(19) United States
(12) Patent Application Publication
(10) Pub. No.: US 2026/0220940 A1
(43) Pub. Date: Jul. 30, 2026

(54) METHOD FOR ADJUSTING ACCUMULATION INTERVAL IN OBJECT DETECTION SYSTEM BASED ON EVENT SIGNAL ACCUMULATION

(71) Applicant: KWANGWOON UNIVERSITY INDUSTRY-ACADEMIC COLLABORATION FOUNDATION, Seoul (KR)

(72) Inventors: Dong Gyu SIM, Seoul (KR); Young Bok LEE, Seoul (KR)

(21) Appl. No.: 19/143,353

(22) PCT Filed: Oct. 25, 2023
(86) PCT No.: PCT/KR2023/016687

§ 371 Date: Jun. 25, 2025

(30) Foreign Application Priority Data
Dec. 26, 2022 (KR) 10-2022-0184850

(51) Int. Cl. G06V 20/40; G06V 10/26; G06V 10/34

(52) U.S. Cl. CPC G06V 20/44; G06V 10/26; G06V 10/34; G06V 20/46

(57) ABSTRACT

A dynamic event signal accumulation method of the present disclosure may comprise: a frame conversion step of converting, into a two-dimensional frame type, event signals acquired through a dynamic vision sensor, so as to acquire first event frames; a same-interval signal accumulation step of summing the first event frames having the same coordinates from among the first event frames, so as to acquire second event frames; a slicing step for dividing the second event frames into patch units; an additional-accumulation-necessity determination step of determining whether an additional accumulation of frames is required for the second event frames; and a morphological calculation step of performing a morphological calculation with respect to the second event frame if the additional accumulation of the frames is not required.

### TECHNICAL FIELD

The present disclosure relates to a technology for dynamically adjusting the number of required accumulated frames based on the connection structure of an event signal in order to efficiently determine the amount of event signals to be accumulated when accumulating event signals acquired through a dynamic vision sensor and acquire a meaningful event signal as the input signal of an object detection system.

### BACKGROUND ART

Through an event signal acquired from a dynamic vision sensor, a 2-D coordinate and whether an event signal occurs at a corresponding coordinate can be known. In order to apply the computer vision technology by using this event signal information, the technology exists that converts an event signal into an event frame and accumulates it. However, since the technology that accumulates a fixed number of frames does not reflect the relative speed change of an object and a camera, the same event may appear differently after accumulation.

### DISCLOSURE

### Technical Problem

The present disclosure does not define the number of frames to be accumulated as a fixed value in advance when accumulating event frames, but may adaptively change it into a suitable number of accumulated frames according to situations. Determining the number of accumulated frames belongs to an important parameter, especially in application such as a road driving situation. Through a probability-based model, an event signal accumulation interval suitable for a real-time environment may be efficiently adjusted.

### Technical Solution

As a means for achieving the above-described technical problem, the event signal accumulation interval adjustment method of the present disclosure slices a converted event frame in the unit of a patch. Based on the same interval signal accumulation, a circuit for determining whether additional accumulation is necessary according to a slicing mode is configured to generate an optimal accumulated frame and strengthen the structural features of an accumulated frame through a morphological operation step.

The dynamic event signal accumulation method and device of the present disclosure includes a frame conversion step for converting event signals acquired through a dynamic vision sensor into a form of a two-dimensional frame to acquire first event frames, a same interval signal accumulation step for summing up first event frames having the same coordinate among the first event frames to acquire a second event frame, a slicing step for partitioning the second event frame in a unit of a patch, an additional accumulation necessity determination step for determining whether additional accumulation of frames is required for the second event frame, and a morphological operation step for performing a morphological operation on the second event frame when the additional accumulation of the frames is not required, wherein whether the additional accumulation of the frames is required may be determined based on a Kullback-Leibler distance, and the Kullback-Leibler distance may be calculated by connecting coordinates having a non-zero value within patches of the second event frame with a line segment and calculating a vector inner product between connecting lines.

In the dynamic event signal accumulation method and device of the present disclosure, when the additional accumulation of the frames is required, the same interval signal accumulation step may be performed again based on new first event frames.

In the dynamic event signal accumulation method and device of the present disclosure, when the Kullback-Leibler distance is greater than a threshold, it may be determined that the additional accumulation of the frames is required, and when the Kullback-Leibler distance is less than the threshold, it may be determined that the additional accumulation of the frames is not required.

In the dynamic event signal accumulation method and device of the present disclosure, a partition method in the slicing step is performed by a first mode and a second mode, and the first mode may be any one of a scalable mode or a non-scalable mode, and the second mode may be a non-overlapping slicing mode or an overlapping slicing mode.

In the dynamic event signal accumulation method and device of the present disclosure, the non-overlapping slicing mode may be divided into a non-overlapping basic mode or a non-overlapping border merge mode, and the non-overlapping basic mode may be a mode for partitioning the second event frame into patches of the same size, and the non-overlapping border merge mode may be a mode for partitioning the second event frame into patches, but merging patches located at a border to generate a new frame.

In the dynamic event signal accumulation method and device of the present disclosure, the merging may be performed in at least one of a horizontal direction or a vertical direction according to a position of the patches located at the border.

In the dynamic event signal accumulation method and device of the present disclosure, when the position of the patches located at the border is a top and a bottom of the second event frame, merging in a horizontal direction may be performed, and when the position of the patches located at the border is a left and a right of the second event frame, the merging in the horizontal direction may be performed.

### Advantageous Effect

The present disclosure may reduce the variation of accumulated frames according to a minute relative speed difference in vehicles by dynamically adjusting an event signal accumulation time. It may improve a dynamic adjustment method for simply adding an event signal in a frame and comparing it with a threshold. An event signal for aerial and vehicle hoods may be separated to independently process front and side event signals. The structural features of an event signal, not the strength of the existing event signal, may be considered. Since a previous accumulated frame probability distribution is referenced, the number of accumulated frames suitable for a situation may be derived.

### BRIEF DESCRIPTION OF DRAWINGS

FIG. 1 shows the dynamic event signal accumulation method of the present disclosure.

FIG. 2 shows a process for performing the slicing step of the present disclosure.

FIG. 3 shows the non-overlapping slicing mode performance method of the present disclosure.

FIG. 4 shows a process for performing the additional accumulation necessity determination step of the present disclosure.

FIG. 5 shows a process for performing the morphological operation step of the present disclosure.

FIGS. 6 and 7 show a method for performing a non-overlapping basic mode and a non-overlapping border merge mode in FIG. 3 as an embodiment of the present disclosure.

### BEST MODE

The dynamic event signal accumulation method of the present disclosure includes a frame conversion step for converting event signals acquired through a dynamic vision sensor into a form of a two-dimensional frame to acquire first event frames, a same interval signal accumulation step for summing up first event frames having the same coordinate among the first event frames to acquire a second event frame, a slicing step for partitioning the second event frame in a unit of a patch, an additional accumulation necessity determination step for determining whether additional accumulation of frames is required for the second event frame, and a morphological operation step for performing a morphological operation on the second event frame when the additional accumulation of the frames is not required, wherein whether the additional accumulation of the frames is required may be determined based on a Kullback-Leibler distance, and the Kullback-Leibler distance may be calculated by connecting coordinates having a non-zero value within patches of the second event frame with a line segment and calculating a vector inner product between connecting lines.

### MODE FOR INVENTION

Hereinafter, referring to attached drawings, the embodiment of the present invention will be described in detail so that those skilled in the art may easily implement it in the technical field to which the present invention belongs. However, the present invention may be implemented in different forms and is not limited to embodiments described herein. In addition, in order to clearly explain the present invention in drawings, parts that are not related to the description are omitted, and similar drawing signs are attached to similar parts throughout the specification.

Throughout the specification, when a part is said to be connected to another part, it includes not only a case where it is directly connected, but also a case where it is electrically connected with other elements in between. In addition, when a part is said to include a component, it means that instead of excluding other components, other components may be further included, unless otherwise specifically opposed.

Throughout the specification, when a part is said to include a component, it means that instead of excluding other components, other components may be further included, unless otherwise specifically opposed. The term of degree such as ‘step for ~’ or ‘step of~’ used throughout the specification does not mean a step for ~.

In addition, although terms ‘first’, ‘second’, etc. may be used to describe various components, the components should not be limited by the terms. The terms are used only to distinguish one component from other components.

In addition, as construction units shown in an embodiment of the present disclosure are independently shown to represent different characteristic functions, it does not mean that each construction unit is composed in a construction unit of separate hardware or one software. In other words, as each construction unit is described by being enumerated as each construction unit for convenience of a description, at least two construction units of each construction unit may be combined to form one construction unit or one construction unit may be divided into a plurality of construction units to perform a function. An integrated embodiment and a separate embodiment of each construction unit are also included in a scope of a right of the present disclosure unless they are beyond the essence of the present disclosure.

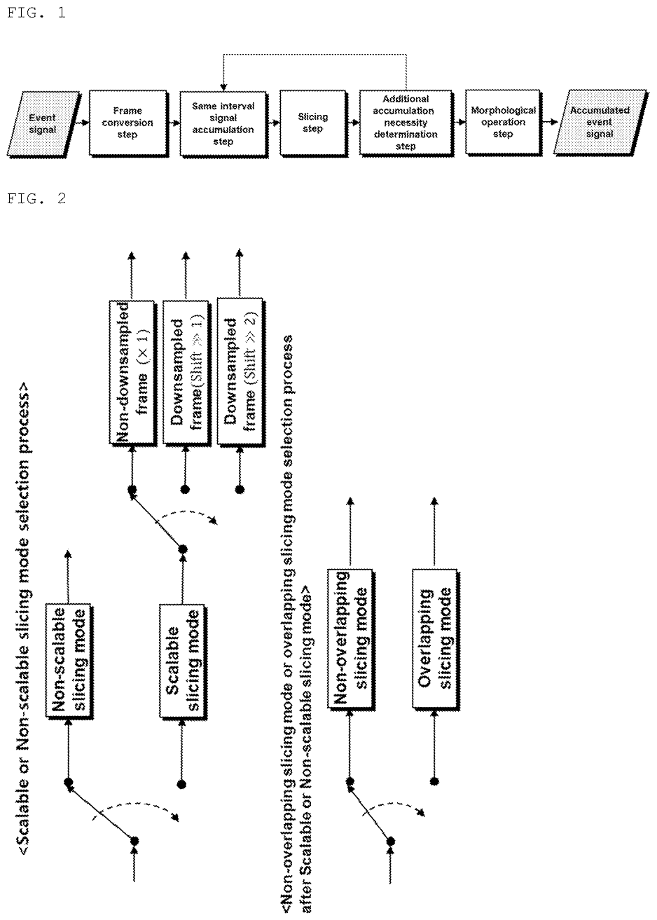

FIG. 1 shows the dynamic event signal accumulation method of the present disclosure.

The dynamic event signal accumulation method of the present disclosure may include at least one of a frame conversion step, a same interval signal accumulation step, a slicing step, an additional accumulation necessity determination step or a morphological operation step.

A frame conversion step may be performed in a frame converter, and the remaining steps may be performed in an accumulated event signal generator.

In the dynamic event signal accumulation method of the present disclosure, the same frame interval signal accumulator may perform accumulation by frames in a fixed minimum unit. The frames may be converted into 2-D frames. A converted frame may be divided in the unit of a patch. According to the position of a screen, patches located in the center, left, right, top, bottom and diagonal may be merged to generate a frame of a new size. Binarization may be performed on a newly generated frame based on a threshold. A binarized value may be defined as a node, and the connection structure of nodes may be obtained by connecting line segments between adjacent nodes. When there is no consistency in a connection structure, a connection relationship may be eliminated, and the probability distribution of a final connection structure may be drawn to calculate the temporally adjacent probability distribution drawn in the past and the Kullback-Leibler divergence distance. When the Kullback-Leibler divergence distance is farther than a set threshold, accumulation may be performed again by frames in the minimum unit. A morphological operation may be performed on accumulated frames. Hereinafter, each step is described in detail.

The ‘frame conversion step’ of the present disclosure uses an event signal acquired through a dynamic vision sensor as an input value, and may convert the event signal into a 2-dimension (2-D) frame with the (x, y) coordinate.

The ‘same interval signal accumulation step’ of the present disclosure may express an event signal (=an event frame) converted into a frame by summing up signals having the same (x, y) coordinate with 2 bits or more.

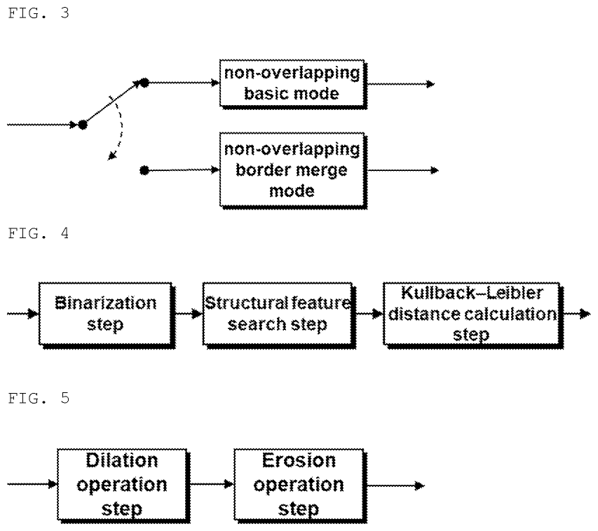

FIG. 2 shows a process for performing the slicing step of the present disclosure.

The ‘slicing step’ of the present disclosure may divide a converted frame (=event frame) in the unit of a patch. A mode applied in dividing in the unit of patch may be divided into a scalable mode or a non-scalable mode and a non-overlapping mode or an overlapping mode.

A scalable mode may be a method for generating frames obtained by downsampling an event frame on horizontal and vertical axes and applying all algorithms included in a system to generated frames.

The downsampling may be performed through a shift operation. As an example, it may be performed by the ‘shift>>1’ operation or the ‘shift>>2’ operation.

In addition, a scalable mode may include the first method that does not perform downsampling but applies the algorithms of a system, the second method that performs downsampling by the first shift operation and applies the algorithms of a system and the third method that performs downsampling by the second shift operation and applies the algorithms of a system.

A non-scalable mode does not apply a scalable mode, which may be a method that does not downsample an event frame and does not apply algorithms included in a system to an event frame.

A non-overlapping slicing mode and an overlapping slicing mode are modes that are applied after scalable and non-scalable modes are applied, and only any one of the two modes may be applied.

An overlapping slicing mode may be a method that divides an event frame into small frames whose areas may overlap each other. ‘An overlapping slicing mode’ is a method that slices the inside of a frame at a fixed interval and generates fixed-size patches. The fixed-size patches may overlap within one frame, and there may be a coordinate that does not belong to a patch within a frame.

A non-overlapping slicing mode may be a method that divides an event frame into small frames whose areas do not overlap each other.

FIG. 3 shows the non-overlapping slicing mode performance method of the present disclosure.

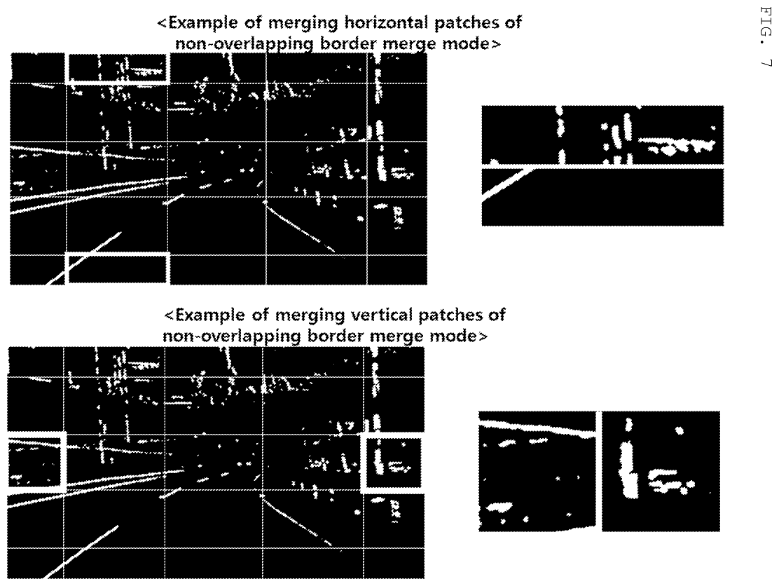

FIGS. 6 and 7 show a method for performing a non-overlapping basic mode and a non-overlapping border merge mode in FIG. 3 as an embodiment of the present disclosure.

A non-overlapping slicing mode may include a non-overlapping basic mode or a non-overlapping border merge mode.

The ‘non-overlapping basic mode’ of FIG. 3 is a method for cutting size of patches to be sliced in the same size. As an embodiment, FIG. 6 shows a slicing example of a non-overlapping basic mode. In the non-overlapping basic mode of FIG. 6, it may be confirmed that an aspect ratio between a patch located at a border and a patch located at the center is 1:1.

The ‘non-overlapping border merge mode’ of FIG. 3 is a method for setting the patch size of a border to be sliced small and then merging the vertices of a frame or horizontal or vertical edges into a new patch. As an embodiment, FIG. 6 shows a slicing example of a non-overlapping border merge mode. In the non-overlapping border merge mode of FIG. 6, it may be confirmed that an aspect ratio between a patch located at a border and a patch located at the center is not 1:1. In addition, it shows an example in which patches located at a border are merged to generate a new frame (or a new patch).

FIG. 7 shows an example in which patches located at a border are merged in a horizontal direction or a vertical direction.

Referring to FIG. 7, patches located at the top and bottom of a border excluding an edge may be merged in a horizontal direction. In addition, patches located at the left and right of a border excluding an edge may be merged in a vertical direction. In addition, four patches located at the edge of a border may be merged in vertical and horizontal directions.

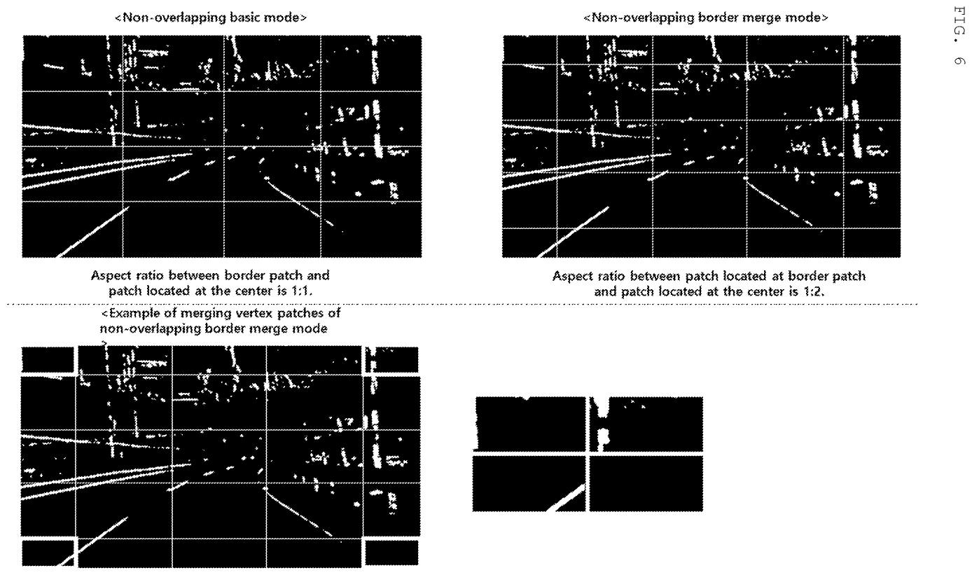

FIG. 4 shows a process for performing the additional accumulation necessity determination step of the present disclosure.

The ‘additional accumulation necessity determination step’ of the present disclosure may include a binarization step, a structural feature search step and a Kullback-Leibler distance calculation step.

The ‘binarization step’ of FIG. 4 may optionally replace the value of each coordinate with 0 or 1. In addition, a binarized value may be defined as a node, and the connection structure of nodes may be obtained by connecting line segments between adjacent nodes.

The ‘structural feature search step’ of FIG. 4 may identify the internal structural features of binarized or non-binarized patches. A connection structure search step may connect coordinates with a non-zero value inside patches with line segments and measure the consistency of connections as a scalar value by calculating an inner product between the vectors of each generated connecting line. When the consistency of connections does not exceed a desired value, a connection between coordinates may be released.

The ‘Kullback-Leibler distance calculation step’ of FIG. 4 may calculate a Kullback-Leibler distance between the connection distribution measured in a connection structure search step in a frame where accumulation is recently completed and the connection distribution in a frame where accumulation is currently performed. The connection distribution may draw the probability distribution for the number of line segments required to form a consistent connection and the number of connections composed of the number of line segments forming a connection. When a scalable mode is selected in the ‘slicing step’ of FIG. 2, a Kullback-Leibler distance may be calculated for all downsampled frames. When a compared Kullback-Leibler distance is greater than a threshold, it may be sent to the ‘same interval signal accumulator’ of FIG. 1, and when a Kullback-Leibler distance is less than a threshold, it may move on to the ‘morphological operation step’ of FIG. 1. If an overlapping slicing mode is selected in the slicing step of FIG. 2, the number of overlapping frames may be adjusted according to a set IOU (Intersection of Union) value.

FIG. 5 shows a process for performing the morphological operation step of the present disclosure.

The ‘morphological operation step’ of the present disclosure may include a dilation operation step and an erosion operation step. The size and shape of a structural element kernel may vary. A dilation operation may be unconditionally filled with 1 when the area filled with 1 of a structural element kernel and an input signal filled with non-zero values overlap even in one pixel. An erosion operation may be unconditionally filled with 0 when the area filled with 1 of a structural element kernel and an input signal filled with non-zero values do not completely overlap.

The exemplary methods of the present disclosure are described as a series of operations for clarity of explanation, but this is not intended to limit the order in which the steps are performed, and when necessary, each step may be performed simultaneously or in a different order. In order to implement a method according to the present disclosure, another step may be additionally included in an exemplary step or the remaining steps may be included excluding some steps or another additional step may be included excluding some steps.

The various embodiments of the present disclosure do not list all possible combinations, but are intended to describe the representative aspect of the present disclosure, and matters described in various embodiments may be applied independently or in a combination of at least two.

In addition, the various embodiments of the present disclosure may be implemented by hardware, firmware, software or a combination thereof. For implementation by hardware, they may be implemented by one or more ASICs (Application Specific Integrated Circuits), DSPs (Digital Signal Processors), DSPDs (Digital Signal Processing Devices), PLDs (Programmable Logic Devices), FPGAS (Field Programmable Gate Arrays), general processors, controllers, microcontrollers, microprocessors, etc.

The range of the present disclosure includes software or machine-executable instructions (i.e., an operating system, an application, firmware, a program, etc.) that enable operations according to the methods of various embodiments to be executed on a device or computer, and a non-transitory computer-readable medium in which such software or instructions are stored and executable on a device or computer.

### INDUSTRIAL APPLICABILITY

The present disclosure may be utilized in the field of processing dynamic event signals.

1. A dynamic event signal accumulation method, the method comprising:
a frame conversion step for converting event signals acquired through a dynamic vision sensor into a form of a two-dimensional frame to acquire first event frames;
a same interval signal accumulation step for summing up first event frames having a same coordinate among the first event frames to acquire a second event frame;
a slicing step for partitioning the second event frame in a unit of a patch;
an additional accumulation necessity determination step for determining whether an additional accumulation of frames is required for the second event frame; and
a morphological operation step for performing a morphological operation on the second event frame when the additional accumulation of the frames is not required,
wherein whether the additional accumulation of the frames is required is determined based on a Kullback-Leibler distance, and
wherein the Kullback-Leibler distance is calculated by connecting coordinates having a non-zero value within patches of the second event frame with a line segment and calculating a vector inner product between connecting lines.

2. The method of claim 1, wherein:
when the additional accumulation of the frames is required, the same interval signal accumulation step is performed again based on new first event frames.

3. The method of claim 1, wherein:
when the Kullback-Leibler distance is greater than a threshold, it is determined that the additional accumulation of the frames is required, and
when the Kullback-Leibler distance is less than the threshold, it is determined that the additional accumulation of the frames is not required.

4. The method of claim 1, wherein:
a partition method in the slicing step is performed by a first mode and a second mode,
the first mode is any one of a scalable mode or a non-scalable mode, and
the second mode is a non-overlapping slicing mode or an overlapping slicing mode.

5. The method of claim 4, wherein:
the non-overlapping slicing mode is divided into a non-overlapping basic mode or a non-overlapping border merge mode,
the non-overlapping basic mode is a mode for partitioning the second event frame into patches of a same size, and
the non-overlapping border merge mode is a mode for partitioning the second event frame into patches, but merging patches located at a border to generate a new frame.

6. The method of claim 5, wherein:
the merging is performed in at least one of a horizontal direction or a vertical direction according to a position of the patches located at the border.

7. The method of claim 6, wherein:
when the position of the patches located at the border is a top and a bottom of the second event frame, merging in the horizontal direction is performed, and
when the position of the patches located at the border is a left and a right of the second event frame, the merging in the horizontal direction is performed.

8. A dynamic event signal accumulation device, the device comprising:
a frame converter for converting event signals acquired through a dynamic vision sensor into a form of a two-dimensional frame to acquire first event frames; and
an accumulated event signal generator for summing up first event frames having a same coordinate among the first event frames to acquire a second event frame,
partitioning the second event frame in a unit of a patch,
determining whether an additional accumulation of frames is required for the second event frame, and
performing a morphological operation on the second event frame when the additional accumulation of the frames is not required,
wherein whether the additional accumulation of the frames is required is determined based on a Kullback-Leibler distance, and
wherein the Kullback-Leibler distance is calculated by connecting coordinates having a non-zero value within patches of the second event frame with a line segment and calculating a vector inner product between connecting lines.

9. The device of claim 8, wherein:
when the additional accumulation of the frames is required, a new second event frame is acquired based on new first event frames without performing the morphological operation.

10. The device of claim 8, wherein:
when the Kullback-Leibler distance is greater than a threshold, it is determined that the additional accumulation of the frames is required, and
when the Kullback-Leibler distance is less than the threshold, it is determined that the additional accumulation of the frames is not required.

11. The device of claim 8, wherein:
a partition method in the slicing step is performed by a first mode and a second mode,
the first mode is any one of a scalable mode or a non-scalable mode, and
the second mode is a non-overlapping slicing mode or an overlapping slicing mode.

12. The device of claim 11, wherein:
the non-overlapping slicing mode is divided into a non-overlapping basic mode or a non-overlapping border merge mode,
the non-overlapping basic mode is a mode for partitioning the second event frame into patches of a same size, and
the non-overlapping border merge mode is a mode for partitioning the second event frame into patches, but merging patches located at a border to generate a new frame.

13. The device of claim 12, wherein:
the merging is performed in at least one of a horizontal direction or a vertical direction according to a position of the patches located at the border.

14. The device of claim 13, wherein:
when the position of the patches located at the border is a top and a bottom of the second event frame, merging in the horizontal direction is performed, and
when the position of the patches located at the border is a left and a right of the second event frame, the merging in the horizontal direction is performed.
